(19) United States
(12) Patent Application Publication
(10) Pub. No.: US 2003/0188080 A1
(43) Pub. Date: Oct. 2, 2003

(54) Apparatus, method and system for remote registered peripheral component interconnect bus

(76) Inventor: Sompong Paul Olarig, Pleasanton, CA (US)

Correspondence Address: Michael G. Fletcher, Fletcher, Yoder & Van Someren, P.O. Box 692289, Houston, TX, 77269-2289, US

(21) Appl. No.: 10/109,290

(22) Filed: Mar. 28, 2002

(51) Int. Cl. G06F 13/20

(52) U.S. Cl. 710/313

(57) ABSTRACT

A multiple use core logic chip set is provided in a computer system that may be configured either as a bridge between a local Registered Peripheral Component Interconnect (“PCI-X”) bus and host and memory buses, as a bridge between a remote PCI-X bus and the host and memory buses, or as a bridge between a primary PCI-X bus and the remote-PCI-X bus. The function of the multiple use chip set is determined at the time of manufacture of the computer system or in the field whether a PCI-X bus bridge or a remote-PCI-X bus bridge is to be implemented. Selection of the configuration of the bus bridge in the multiple use core logic chip set may be made by a hardware signal input, or by software during computer system configuration or power on self test (“POST”). Software configuration may also be determined upon detection of either a PCI device or a PCI-X device connected to the common PCI-X bus.

### BACKGROUND OF THE INVENTION

1. Field of the Invention

The present invention relates to computer systems using core logic circuits as a bus bridge(s) to interface a central processor(s), video graphics processor, memory and input-output peripherals together, and more particularly, in utilizing the same core logic circuits as a bus bridge for either a local registered peripheral component interconnect bus or a remote registered peripheral component interconnect bus.

2.Description of the Related Art

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Use of computers, especially personal computers, in business and at home is becoming more and more pervasive because the computer has become an integral tool of most information workers who work in the fields of accounting, law, engineering, insurance, services, sales and the like. Rapid technological improvements in the field of computers have opened up many new applications heretofore unavailable or too expensive for the use of older technology mainframe computers. These personal computers may be used as stand-alone workstations (high end individual personal computers) or linked together in a network by a “network server” which is also a personal computer which may have additional features specific to its purpose in the network. The network server may be used to store massive amounts of data, and may facilitate interaction of the individual workstations connected to the network for electronic mail (“E-mail”), document databases, video teleconferencing, whiteboarding, integrated enterprise calendar, virtual engineering design and the like. Multiple network servers may also be interconnected by local area networks (“LAN”) and wide area networks (“WAN”).

A significant part of the ever increasing popularity of the personal computer, besides its low cost relative to just a few years ago, is its ability to run sophisticated programs and perform many useful and new tasks. Personal computers today may be easily upgraded with new peripheral devices for added flexibility and enhanced performance. A major advance in the performance of personal computers (both workstation and network servers) has been the implementation of sophisticated peripheral devices such as video graphics adapters, local area network interfaces, SCSI bus adapters, full motion video, redundant error checking and correcting disk arrays, and the like. These sophisticated peripheral devices are capable of data transfer rates approaching the native speed of the computer system microprocessor central processing unit (“CPU”). The peripheral devices' data transfer speeds are achieved by connecting the peripheral devices to the microprocessor(s) and associated system random access memory through high speed expansion local buses. Most notably, a high speed expansion local bus standard has emerged that is microprocessor independent and has been embraced by a significant number of peripheral hardware manufacturers and software programmers. This high speed expansion bus standard is called the “Peripheral Component Interconnect” or “PCI.”

Several official specifications and other documents relating to various aspects of the PCI Local Bus are currently available from the PCI Special Interest Group. Some examples of those documents include the PCI Local Bus Specification, revision 2.1; the PCI Local Bus Specification, revision 2.2 (PCI Conventional 2.2 Specification), the PCI-X 1.0a Specification, the Mini PCI Specification, the PCI/PCI Bridge Specification, revision 1.0; the PCI System Design Guide, revision 1.0; the PCI BIOS Specification, revision 2.1, the Small PCI 1.5s Specification, and the Engineering Change Notice (“ECN”) entitled “Addition of ‘New Capabilities’ Structure,” dated May 20, 1996, the disclosures of which are hereby incorporated by reference. These PCI specifications and ECN are available from the PCI Special Interest Group, P.O. Box 14070, Portland, Oreg.97214.

A computer system has a plurality of information (data and address) buses such as a host bus, a memory bus, at least one high speed expansion local bus such as the PCI bus, and other peripheral buses such as the Small Computer System Interface (SCSI), Extension to Industry Standard Architecture (EISA), and Industry Standard Architecture (ISA). The microprocessor(s) of the computer system communicates with main memory and with the peripherals that make up the computer system over these various buses. The microprocessor(s) communicates to the main memory over a host bus to memory bus bridge. The peripherals, depending on their data transfer speed requirements, are connected to the various buses which are connected to the microprocessor host bus through bus bridges that detect required actions, arbitrate, and translate both data and addresses between the various buses.

Increasingly sophisticated microprocessors have revolutionized the role of the personal computer by enabling complex applications software to run at mainframe computer speeds. The latest microprocessors have brought the level of technical sophistication to personal computers that, just a few years ago, was available only in mainframe and mini-computer systems. Some representative examples of these new microprocessors are the “PENTIUM” and “PENTIUM PRO’ (registered trademarks of Intel Corporation). Advanced microprocessors are also manufactured by Advanced Micro Devices, Digital Equipment Corporation, Cyrix, IBM and Motorola.

Faster and more sophisticated microprocessors are here now or will soon be introduce in the near future. The Digital Equipment Corporation “ALPHA” processor runs in excess of 400 MHz and the still in development, Intel Corporation's 64 bit data and address bus width processors (Itanium) is or will soon be available for use in high end computer servers. The ultra high performance Alpha and Merced processors require a great deal of power to operate and thus generate large amounts of heat relative to present technology processors. In addition, multiprocessor configurations of eight or more processors in a computer system further taxes the physical, electrical and thermal packaging of these future super microcomputers. A solution to packaging may require these new processors to occupy their own box with the necessary power supplies and cooling, but without room or capacity for other components necessary to make up a complete computer system. Gigabyte memory and a significant number of external and internal I/O PCI devices and slots may require separate chassis(es) apart from the processor(es) chassis. Thus, remote-PCI has a distinct advantage for more efficient and flexible computer system packaging.

What is needed is an apparatus, method, and system for a personal computer that may provide either a local or a remote-PCI-X bus, depending on the configuration and intended use of the computer.

### SUMMARY OF THE INVENTION

The present invention provides a computer system having a core logic chip set that is capable of supporting either local or remote Registered Peripheral Component Interconnect (“PCI-X”) buses, including remote PCI-X buses. According to the PCI-X specification, all signals are sampled on the rising edge of the PCI bus clock and only the registered version of these signals are used inside the PCI-X devices. In the PCI 2.1 and 2.2 Specifications, there are many cases where the state of an input signal setting up to a particular clock edge affects the state of an output signal after that same clock edge. This type of input-output signal behavior is not possible in a registered interface, thus PCI-X introduces the concept of a clock-pair boundary which replaces some single-clock-edges where control signals change. Timing on the PCI-X bus is not as critical as the aforementioned 66 MHz PCI 2.1 Specification, even when the PCI-X bus runs faster than 133 MHz. The PCI-X Specification allows PCI bus operation with more than two PCI device cards.

The present invention provides a core logic chip set configurable for a remote-PCI-X bus when an additional local PCI-X bus is not needed by utilizing multiple use high production volume logic and interface circuits having the capability of providing either a remote-PCI-X or a local PCI-X interface. The invention also allows an arbiter of the multiple use high production volume logic and interface circuits to be used for either a PCI-X device or a plurality of remote-PCI-X devices. The invention facilitates the use of an arbiter in the remote-PCI bus bridge for arbitration of a plurality of PCI-X devices on the remote-PCI-X bus.

The PCI bus is designed to provide connectivity to very high bandwidth devices such as 3-D graphics and gigabit input-output (“I/O”) devices. 66 MHz PCI devices are recognized by one static signal which replaces an existing ground pin in the 33 MHz PCI 2.1Specification, and one bit added to the Configuration Status register as more fully defined in the PCI 2.1Specification incorporated by reference hereinabove. 66 MHz PCI device bus drivers are basically the same as those used for 33 MHz bus operation but require faster timing parameters and have more critical timing constraints. Thus, the PCI 2.1 and 2.2 Specifications recommend only two PCI connector slots for a PCI bus operating at 66 MHz. However, Both 66 MHz and 33 MHz PCI bus operation are contemplated herein for the present invention. However, the PCI-X operation is a compatible superset of the original PCI 2.1 and 2.2 Specifications.

PCI-X allows for higher clock frequencies such as, for example, 133 MHz in a fully backward-compatible way. PCI-X devices may be designed to meet Registered PCI requirements and still operate as conventional 33 MHz and 66 MHz PCI devices when installed in legacy computer systems. Similarly, if conventional PCI devices are installed in a PCI-X bus, the clock remains at a frequency acceptable to the conventional device, and other devices are restricted to using conventional protocol when communicating with the conventional device. It is expected that this high degree of backward compatibility will enable the gradual migration of systems and devices to bandwidths in excess of 1 GByte/s.

The arbitration rules for PCI-X differ from those of standard PCI. Consequently, the bus arbitration rules have been modified for the bridge in those situations where all devices conform to the PCI-X protocol. However, when one or more devices attached to the bridge obeys only the standard PCI protocol, the standard PCI arbitration rules are used.

The present invention provides a computer system a multiple use core logic chip set that may be configured as either a bridge between a PCI-X bus and host and memory buses, or as an interface between the host and memory buses and a remote-PCI-X bus bridge. The function of the multiple use chip set is determined at the time of manufacture of the computer system or may be changed in the field to a PCI-X bus bridge or an interface for a remote-PCI-X bus bridge. The core logic chip set has provisions for the PCI-X and remote-PCI-X interface signals and is adapted for connection to either the PCI-X bus or the remote-PCI-X bus bridge interface. Selection of which configuration (PCI-X or remote-PCI-X bridge interface) the core logic of the present invention is to assume may be determined by the type of computer system printed circuit motherboard utilized with the core logic chip set or by software configuration during computer system startup (POST) or configuration. The core logic chip set of the present invention uses one of its arbiters and has Request (“REQ”) and Grant (“GNT”) signal lines for the PCI-X device and each PCI-X device on the primary PCI-X bus). The remote-PCI-X bridge has device REQ and GNT signal lines for each PCI-X device on the remote-PCI-X bus.

The remote-PCI-X bridge interface of the present invention may be configured to connect to an expansion cable which is used to join the core logic chip set on the computer system motherboard to a remote-PCI-X interface to PCI-X bus bridge located on a remote expansion box motherboard. The cable passes signals to and from the interface on the computer system motherboard and the interface on the remote expansion box motherboard. One embodiment of the present invention connects the core logic chip set on the computer system motherboard directly to the expansion cable. This embodiment has a built-in cable bus drivers and receivers that may be differentially connected for improved noise rejection. Another embodiment of the present invention connects the core logic chip set to additional PCI-X bus on the computer system motherboard. A PCI-X device card having an interface for and connected to the expansion cable is connected to the additional PCI-X bus either by plugging into a PCI-X connector or being embedded on the computer system motherboard. The former embodiment of the invention combines the expansion cable interface within the core logic of the present invention. The later embodiment uses a PCI-X device card having cable bus drivers and receivers for interfacing with the expansion cable. This PCI-X device card may plug into a PCI-X bus of the computer system which is connected to the core logic. The core logic is configured as a PCI-X bus interface by a hardware input signal or software programming, as disclosed above. PCI-X bus transactions for either of the aforementioned embodiments may be considered for discussion purposes to be the same.

The computer system side of the remote-PCI-X interface may connect to the computer system primary PCI-X bus or it may connect to the host bus and act as a part of a host-to-PCI-X bridge. Either way, a new PCI-X bus is created having a different bus number than the primary PCI-X bus. The expansion cable interface at the remote expansion box, in combination with the expansion cable interface in the computer system, creates a PCI-X bus interface for a downstream PCI-X bus (either downstream from the primary PCI-X bus or downstream from the computer system host bus). Hereinafter the interface and logic on the computer system motherboard will be referred to as the “upstream interface and logic” and the interface and logic on the expansion box motherboard will be referred to as the “downstream interface and logic.”

The downstream interface and logic generates and drives PCI-X clocks in the expansion box at the same frequency as the PCI-X clock of the computer system connected to the upstream interface and logic. Interrupts are supported by the downstream logic in the expansion box. An arbiter in the downstream logic provides REQ and GNT signal lines for each PCI-X device in the expansion box. Multiple downstream PCI-X buses are contemplated by the present invention.. Multiple expansion boxes are also contemplated herein, each with its own downstream interface and logic. Associated upstream interfaces and logic being located in the computer system, and each downstream interface and logic being located in a separate expansion box. Also contemplated are multiple expansion boxes daisy-chained together with upstream and downstream interfaces and logic therebetween.

The embodiments of the invention contemplate a multiple use core logic chip set which may be one or more integrated circuit devices such as an Application Specific Integrated Circuit (“ASIC”), Programmable Logic Array (“PLA”) and the like. A PCI-X device may be embedded on the computer system motherboard, or may be on a separate card which plugs into a corresponding PCI-X card edge connector attached to the system motherboard and connected to the multiple use core logic chip set. The PCI-X card edge connectors are standard PCI connectors as more fully defined in the respective PCI specification.

The multiple use core logic chip set of the present invention may be used in conjunction with a specific use printed circuit motherboard for a workstation, personal computer, portable computer, or a network server. In this embodiment, the type of motherboard may be adapted to apply hardware signal inputs to the core logic chip set for determining the configuration thereof. The multiple use core logic chip set may also be configured to provide the remote-PCI-X interface by software selection and is within the scope of the present invention.

The present invention allows the same multiple use core logic chip set to be used across different types of computer products. This feature increases the quantity of these chip sets being manufactured, thus resulting in a corresponding decrease in the cost per chip set.

The multiple use core logic chip set of the present invention may be used in conjunction with a multiple use or universal printed circuit motherboard having provisions for either a PCI-X card connector or a remote-PCI-X interface connector. The multiple use core logic chip set may also be connected to both a PCI-X connector and a remote-PCI-X interface connector on the universal printed circuit motherboard. Thus, one motherboard and core logic chip set can satisfy the requirements for a computer system having either a primary PCI-X bus and a secondary PCI-X bus, or a primary PCI-X bus and a remote-PCI-X bus interface.

As discussed above, the multiple use core logic chip set may have signal inputs for configuring whether it functions as a local PCI-X interface or a remote-PCI-X bridge interface, however, it is also contemplated in the present invention that the multiple use chip set may be software programmed to select either the local PCI-X or the remote-PCI-X bridge interface function. When the computer system is first powered on and POST begins, the startup configuration software must scan the PCI-X bus or buses to determine what PCI-X devices exist and what configuration requirements they may have. This process is commonly referred to as enumerating, scanning, walking or probing the bus. It may also be referred to as the discovery process. The software program which performs the discovery process may be referred to as the PCI-X bus enumerator.

According to the PCI-X specification all PCI-X devices must implement a base set of configuration registers. The PCI-X device may also implement other required or optional configuration registers defined in the PCI-X specification. The PCI-X specification also defines configuration registers and information to be contained therein for a PCI-X compliant device so as to indicate its capabilities and system requirements. Once the information for all of the bus devices are determined, the core logic may be configured as a remote-PCI-X bridge interface by the startup software.

In the disclosed embodiments, software may determine at POST whether a local PCI-X bus or the remote-PCI-X bus bridge is to be supported by the core logic chip set. This feature makes the core logic chip set of the present invention compatible with any computer system used as a workstation, personal computer, portable, or network server by utilizing the appropriate system motherboard having provisions for the remote-PCI-X bus.

Other features and advantages of the invention will be apparent from the following description of the invention, given for the purpose of disclosure and taken in conjunction with the accompanying drawings.

### BRIEF DESCRIPTION OF THE DRAWINGS

The foregoing and other advantages of the invention will become apparent upon reading the following detailed description and upon reference to the drawings in which:

FIGS. 1 and 1A are schematic block diagram of a computer system having a primary PCI-X bus and a secondary PCI-X bus;

FIG. 2 is a schematic block diagram of a computer system having a primary PCI-X bus and a remote-PCI-X interface, according to an embodiment of the present invention;

FIG. 3 is a schematic block diagram of a computer system having a primary PCI-X bus, and additional PCI-X bus and a remote-PCI-X interface, according to another embodiment of the present invention;

FIG. 4 is a schematic block diagram of an expansion box having a remote-primary PCI-X bus and a remote-PCI-X interface as utilized with the computer systems of FIGS. 2 and 3;

FIG. 5 is a schematic functional block diagram of the embodiments illustrated in FIGS. 2 and 3;

FIG. 6 is a data flow block diagram of FIG. 5;

FIG. 7 is schematic plan view of a computer system motherboard, according to the present invention; and

FIG. 8 is schematic plan view of an expansion box motherboard, according to the present invention; and

FIG. 9 is a schematic block wiring diagram of a portion of the embodiments of the present invention according to FIGS. 7 and 8.

### DETAILED DESCRIPTION OF SPECIFIC EMBODIMENTS

The following patents are hereby incorporated by reference:

U.S. Pat. No. 5,889,970, issued Mar. 30, 1999, entitled “Dual Purpose Apparatus, Method and System for Accelerated Graphics Port and Peripheral Component Interconnect” by Ronald T. Horan and Sompong P. Olarig;

U.S. Pat. No. 5,923,860, issued Jul. 13, 1999, entitled “Apparatus, Method and System for Remote Peripheral Component Interconnect Bus Using Accelerated Graphics Port Logic Circuits” by Sompong P. Olarig;

U.S. Pat. No. 5,878,237, issued Mar. 2, 1999, entitled “Apparatus, Method and System for a Computer CPU and Memory to PCI Bridge Having a Plurality of Physical PCI Buses” by Sompong P. Olarig;

U.S. Pat. No. 5,872,941, issued Feb. 16, 1999, entitled “Providing Data From a Bridge to a Requesting Device While the Bridge is Receiving the Data” by Alan L. Goodrum, et al.;

U.S. Pat. No. 6,024,486, issued Feb. 15, 2000, entitled “Data Error Detection and Correction” by Sompong P. Olarig, et al.;

U.S. Pat. No. 5,872,939, issued Feb. 16, 1999, entitled “Bus Arbitration” by Jens K. Ramsey, et al.; and

U.S. Pat. No. 6,024,486, issued Feb. 15, 2000, entitled “Data Error Detection and Correction” by Sompong P. Olarig et al.

U.S. Pat. No. 6,266,731, issued Jul. 24, 2001, entitled “High Speed Peripheral Interconnect Apparatus, Method and System” by Dwight Riley and Christopher J. Pettey.

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The PCI bus was developed to have sufficient data bandwidth for high performance peripherals such as a video controller, a high speed network interface card(s), a hard disk controller(s), a SCSI adapter, a wide area network digital router, and the like. A PCI bus running at 33 MHz may have a plurality of card connectors attached thereto, however, when the PCI bus runs at 66 MHz the number of card connectors is limited to two because of timing constraints of the digital control signals. Sophisticated graphics and increased network data transfer requirements have put upward pressure on the PCI buses for faster data transfers between the computer system main memory, host processor(s), peripherals and data from other computers on the network. Thus, 66 MHz operation is preferred, and in some cases mandatory, however, a plurality of PCI-to-PCI bus bridges are required to provide enough PCI device card slots for a typical computer system such as a network server or graphics workstation. PCI-to-PCI bus bridges create new PCI bus numbers and introduce increasingly complex data protocol and handshake requirements, multiple delayed transactions, additional bus latency, and potential deadlock cycles.

Registered PCI (“PCI-X”) buses are comprised of a registered peripheral component interconnect bus, logic circuits and signal protocols thereof. According to the PCI-X Specification, all signals are sampled on the rising edge of the PCI bus clock and only the registered version of these signals are used inside the PCI-X devices. In the current PCI 2.1 and 2.2 Specifications, there are many cases where the state of an input signal setting up to a particular clock edge affects the state of an output signal after that same clock edge. This type of input-output signal behavior is not possible in a registered interface, thus PCI-X introduces the concept of a clock-pair boundary which replaces some single-clock-edges where control signals change timing on the PC!-X bus is not as critical as the aforementioned 66 MHz PCI 2.1 and 2.2Specifications, even when the PCI-X bus runs faster than 133 MHz. The PCI-X allows PCI bus operation with more than two PCI device cards.

The arbitration rules for PCI-X differ from those of standard PCI. Consequently, the bus arbitration rules have been modified for the bridge in those situations where all devices conform to the PCI-X protocol. However, when one or more devices attached to the bridge obey only the standard PCI protocol, all transactions are conducted according to the standard PCI protocol, even if the devices involved are PCI-X capable. The standard PCI bus protocol rules can be found in the PCI Specification cited earlier. The PCI-X bus arbitration rules are as follows:

1. All REQ# and GNT# signals are registered by the arbiter a.s well as by all initiators.

2. An initiator is permitted to start a new transaction (drive the AD bus, etc.) on any clock N in which the initiator's GNT# was asserted on clock N-2, and when any of the following three conditions are satisfied:

a) The bus was idle (FRAME# and IRDY# were both deasserted) on clock N-2.

b) The previous transaction was a byte-count transaction, the command was not a reserved command, the extended command was not a reserved validated extended command, and FRAME# was deasserted on clock N-3.

c) The previous transaction was a byte-enable transaction, the command was not a reserved command, the extended command was not a reserved validated extended command, and TRDY# or STOP# was asserted on clock N-3.

3. An initiator is permitted to start a new transaction on clock N even if GNT# is deasserted on clock N-I (assuming the requirements of item 2 above are met).

4. An initiator is permitted to assert and deassert REQ# on any clock. There is no requirement to deassert REQ# after a target termination (STOP# asserted). The arbiter is assumed to monitor bus transactions to determine when a transaction has been target terminated, if the arbiter uses this information to advance to the next bus owner.

5. If all the GN1# signals are deasserted, the arbiter is permitted to assert any GNT# on any clock. After the arbiter asserts GNT# the arbiter can deassert it on any clock. However, the arbiter must fairly provide opportunities for all devices to execute Configuration transactions, which require GNT# to remain asserted for a minimum of live clocks while the bus is idle.

6. If the arbiter deasserts GNT# to one device, it cannot assert GNT# to another device until the next clock.

7. In PCI hot-plug systems, the arbiter must coordinate with the Hot-Plug Controller to prevent hot-plug operations from interfering with other bus transactions.

8. The default Latency Timer value for initiators in PCI-X mode is 31. Configuration software is discouraged from changing the default value.

For illustrative purposes, prior art references and preferred embodiments of the present invention are described hereinafter for computer systems utilizing the Intel x86 microprocessor architecture and certain terms and references will be specific to that processor platform. PCI-X is an interface standard, however, that is hardware independent and may be utilized with any host computer designed for this interface standard. It will be appreciated by those skilled in the art of computer systems that the present invention may be adapted and applied to any computer platform utilizing the PCI-X interface standard including those systems utilizing the Windows, UNIX, OS/2 and Linux operating systems. The PCI-X specification is incorporated U.S. patent application Ser. No. 09,148,042, filed on Sept. 3, 1998 incorporated by reference herein.

The present invention is an apparatus, method and system for providing in a computer system a multiple use core logic chip set capable of implementing either a bridge between the host and memory buses and a PCI-X bus, or a bridge between the host and memory buses and a remote-PCI-X bus located in an expansion box. Another embodiment of the multiple use core logic chip set of the present invention implements either a bridge between the host and memory buses and a PCI-X bus, or a bridge between a primary PCI-X bus and an additional PCI-X bus, wherein an expansion cable interface configured as a plug-in PCI-X device card may be connected to the additional PCI-X bus. Either implementation may he configured by hardware input signals to the multiple use core logic chip set or by software programming thereof.

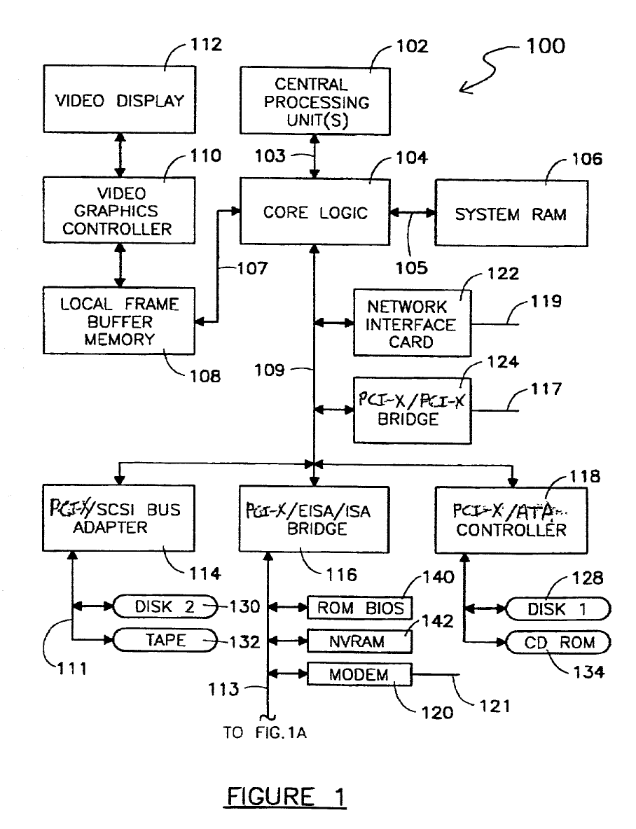

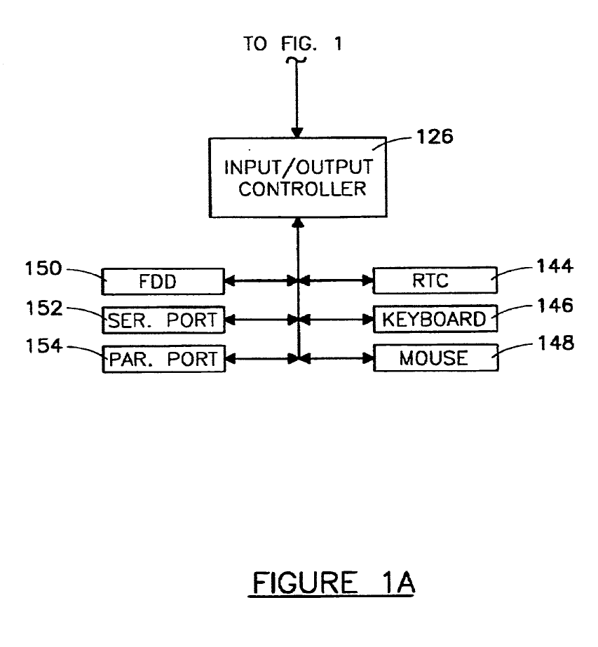

Referring now to the drawings, the details of preferred embodiments of the present invention are schematically illustrated. Like elements in the drawings will be represented by like numbers, and similar elements will be represented by like numbers with a different lower case letter suffix. Referring now to FIGS. 1 and 1 A, a schematic block diagram of a computer system utilizing PCI-X buses is illustrated. The computer system is generally indicated by the numeral 100 and comprises a central processing unit (“CPU”) 102, core logic 104, system random access memory (“RAM”) 106, a video graphics controller 110, a local frame buffer memory 108, a video display 112, a PCI-X/SCSI bus adapter 114, a PCI-X/EISA/ISA bridge 116, and a PCIX/ATA controller 118. Single or multilevel cache memory (not illustrated) may also be included in the computer system 100 according to the current art of microprocessor computers. The CPU 102 may be a plurality of CPUs 102 in a symmetric or asymmetric multi-processor configuration.

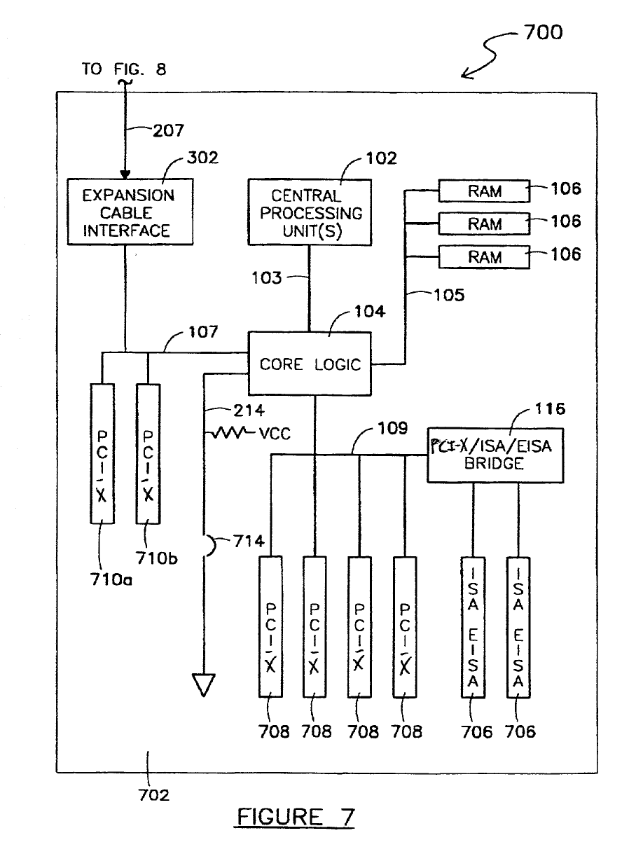

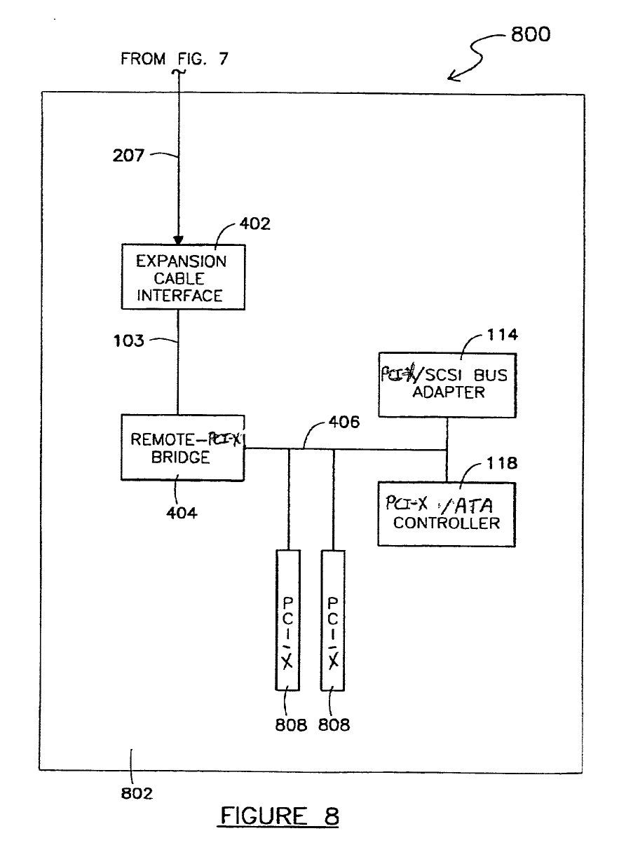

The CPU 102 is connected to the core logic 104 through a host bus 103. The system RAM 106 is connected to the core logic 104 through a memory bus 105. The video graphics controller 110 is connected to the local frame buffer memory 108 which is connected to the core logic 104 through an Accelerated Graphics Port (“AGP”) or an additional PCI or PCI-X bus 107. The PCI-X/SCSI bus adapter 114, PCI-X/EISA/ISA bridge 116, and PCI-X/ATA controller 118 are connected to the core logic 104 through a PCI-X bus 109. Also connected to the PCI-X bus 109 are a network interface card (“NIC”) 122, and a PCI-X/PCI-X bridge 124. Some of the PCI-X devices such as the NIC 122 and PCI-X/PCI-X bridge 124 may plug into PCI-X connectors on the computer system 100 motherboard (FIG. 7).

Hard disk 130 and tape drive 132 are connected to the PCI-X/SCSI bus adapter 114 through a SCSI bus 111. The NIC 122 is connected to a local area network 119. The PCIX/EISA/ISA bridge 116 connects over an EISA/ISA bus 113 to a ROM BIOS 140, non-volatile random access memory (NVRAM) 142, modem 120, and input-output controller 126. The modem 120 connects to a telephone line 121. The input-output controller 126 interfaces with a keyboard 146, real time clock (RTC) 144, mouse 148, floppy disk drive (“FDD”) 150, and serial/parallel ports 152, 154. The EISA/ ISA bus 113 is a slower information bus than the PCI-X bus 109, but it costs less to interface with the EISA/ISA bus 113. The PCI-X/ATA controller 118 interfaces to an ATA disk 128 and ATA CD ROM drive 134.

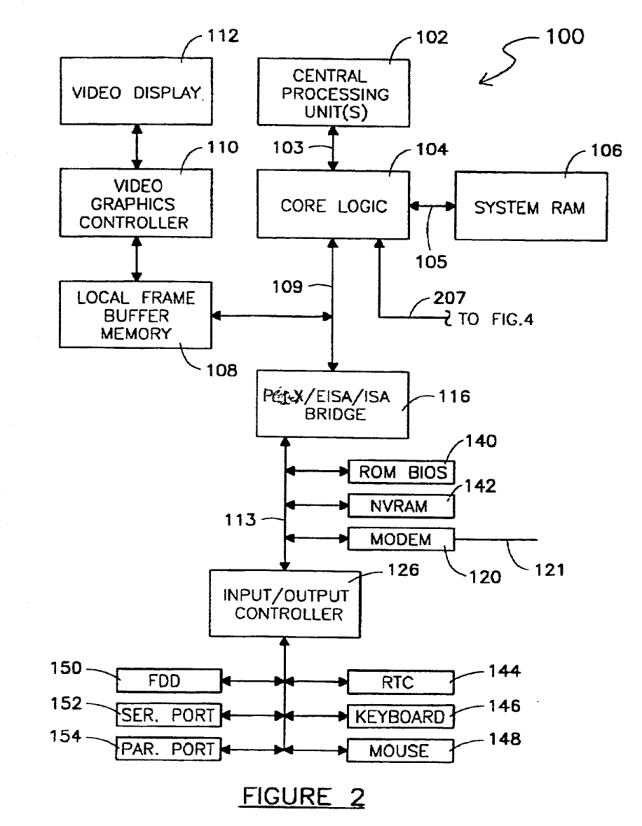

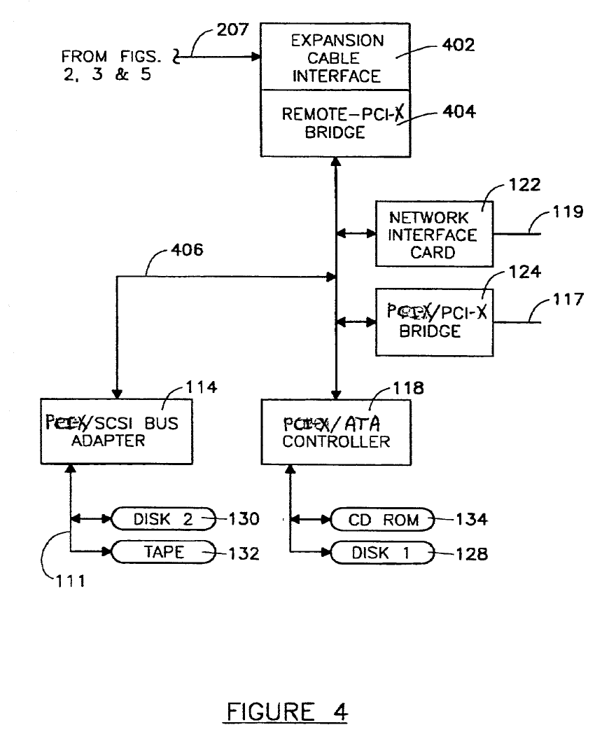

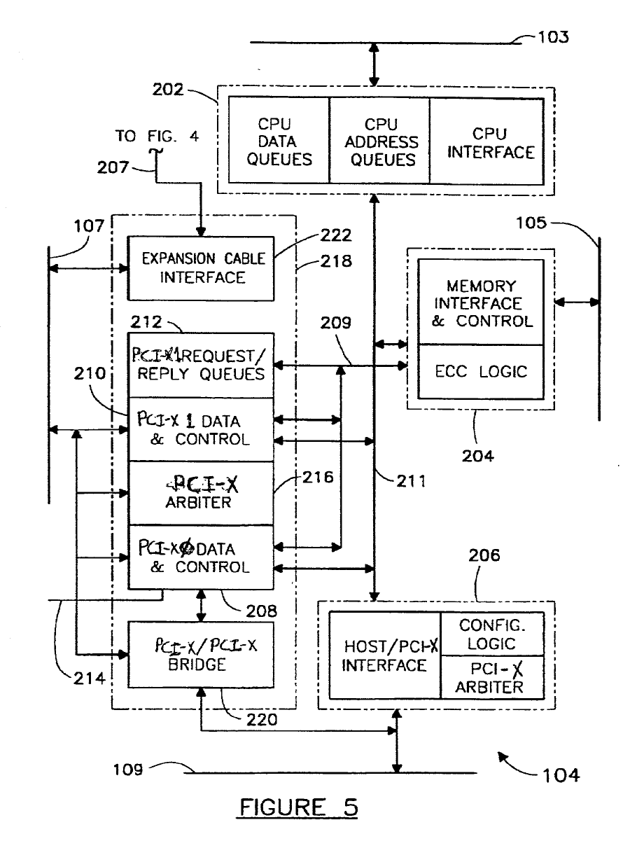

Referring now to FIGS. 2 and 4, schematic block diagrams of a computer system having a primary PCI-X bus on a computer motherboard (see FIG. 7) and a remote-PCI-X bus on an expansion box motherboard (see FIG. 8) are illustrated. In the embodiment of FIG. 2, the local frame buffer memory 108 is connected to the primary PCI-X bus 109 and an expansion cable 207 connects to the core logic 104. The core logic 104 may include an expansion cable interface 222 (FIG. 5) having differential cable drivers and receivers (not illustrated) to interface with the expansion cable 207 which may be comprised of a plurality of twisted pairs of insulated wire that are shielded or unshielded. The expansion cable 207 connects to a cable interface 402 on the expansion box motherboard. The cable interface 402 on the expansion box motherboard also has differential cable drivers and receivers and is similar to the expansion cable interface 222 in the core logic 104. A remote-PCI-X bridge 404 is connected to the expansion cable interface 402. The remote-PCI-X bridge 404 is connected to the remote-PCI-X bus 406 and peripheral devices, as described above, are connected to this remote-PCI-X bus 406. Alternatively, the expansion cable 207 may be optical fiber cable, provided that the core logic 104 and the cable interface 402 are adapted to transmit and/or receive data via optical fiber.

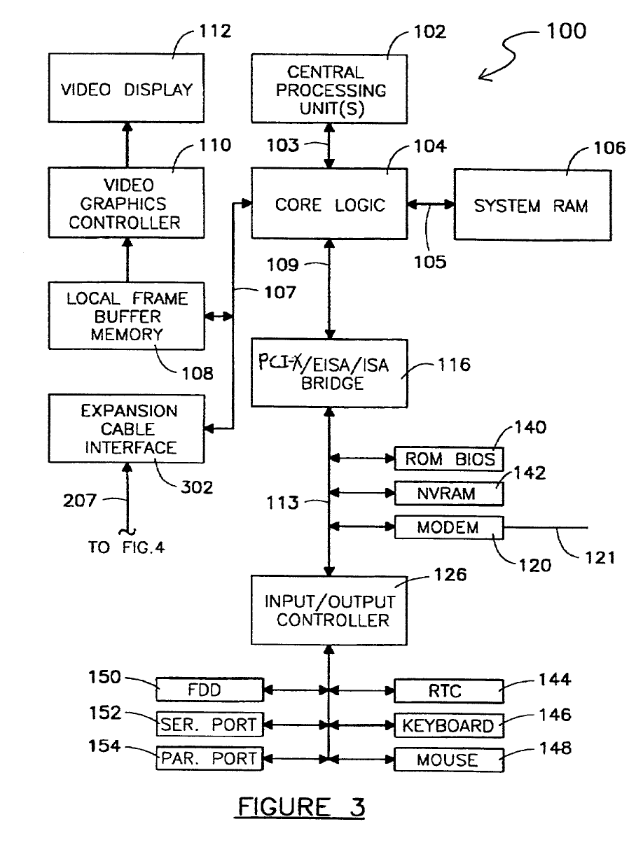

Referring now to FIG. 3, a schematic block diagram of a computer system having a primary PCI-X bus 109 and an additional PCI-X bus 107 is illustrated. The core logic 104 is configured for the PCI-X buses 109, 107. A separate PCI-X device card having an expansion cable interface 302 thereon may be plugged into either of these PCI-X buses 109, 107 (connection to PCI-X bus 107 is illustrated). Operation of this embodiment of the invention is the same as described above for the embodiment illustrated in FIG. 2, except that the interface for the expansion cable 207 is on the PCI-X card 302 and not in the core logic 104.

Referring now to FIG. 5, a schematic functional block diagram of the core logic 104 of FIGS. 2 and 3, according to the present invention, is illustrated. The core logic 104 functionally comprises a CPU host bus interface and queues 202, memory interface and control 204, host/PCI-X bridge 206, and PCI/PCI-X logic 218. The PCI/PCI-X logic 218 comprises PCI-X bus 0 data and control 208, PCI-X bus arbiter 216, PCI-X bus 1 data and control 210, and PCI-X bus 1 request/reply queues 212. A user may choose to enable the components of PCI/PCI-X logic 218 to operate as a local PCI-X compliant interface or a remote PCI-X compliant interface, depending on the implementation of the particular computer system.

The CPU host bus interface and queues 202 connects to the host bus 103 and includes interface logic for all data, address and control signals associated with the CPU 102 of the computer system 100. Multiple CPUs 102 and cache memory (not illustrated) are contemplated and within the scope of the present invention. The CPU host bus interface and queues 202 interfaces with the host/PCI bridge 206 and memory interface and control 204 over a core logic bus 211. The CPU host bus interface and queues 202 interfaces with the PCI data and control 208, PCI-X bus 1 data and control 210, and PCI-X bus 1 request/reply queues 212 over a core logic bus 211. The memory interface and control 204 interfaces with the PCI-X bus 0 data and control 208, PCI-X bus 1 data and control 210, and PCI-X bus 1 request/reply queues 212 over a core logic bus 209. An advantage of having individual core buses 209 and 211 is that concurrent bus operations may be performed thereover. For example, video data stored in system RAM 106 may he transferring to the video graphics controller 110 while the CPU 102 on the host bus 103 is accessing an independent PCI-X device (i.e., NIC 122) on the PCI-X bus 109.

The host bus interface and queues 202 allows the CPU 102 to pipeline cycles and schedule snoop accesses. The memory interface and control 204 controls the control and timing signals for the computer system RAM 106, which may be synchronous dynamic RAM or any other type of memory device. The memory interface and control 204 has an arbiter (not illustrated) which selects among memory accesses for CPU writes, CPU reads, PCI-X writes, PCI-X reads and dynamic memory refresh. Arbitration may he pipelined into a current memory cycle, which insures that the next memory address is available on the memory bus 105 before the current memory cycle is complete. This results in minimum delay, if any, between memory cycles. The memory interface and control 204 also is capable of reading ahead on PCI initiator reads when a PCI initiator issues a read split transaction.

The host/PCI-X bridge 206 controls the interface to the PCI-X bus 109. When the CPU 102 accesses the PCI-X bus 109, the host/PCI-X bridge 206 operates as a PCI-X initiator. When a PCI-X device is an initiator on the PCI-X bus 109, the host/PCI-X bridge 206 operates as a PCI-X target. The host/PCI-X bridge 206 contains base address registers for a PCI-X device target (not illustrated).

The PCI-X logic 218 comprises a PCI-X/PCI-X bridge 220, PCI-X bus 0 data and control 208, PCI-X arbiter 216, PCI-X bus 1 data and control 210, and PCI-X bus 1 request/reply queues 212. The PCI-X bus 0 data and control 208, PCI-X bus 1 data and control 210, and PCI-X bus 1 request/reply queues 212 interface to a PCI-X bus 107 having signal, power and ground connections (not illustrated) for implementation of the PCI-X standard. PCI/PCI-X control 214 may be used to select the personality function of the PCI/PCI-X logic 218 to be a local PCI-X compliant interface or to be a remote PCI-X compliant interface, depending on the desired purpose and configuration of the computer system 100. The PCI/PCI-X control 214 may be implemented in hardware (jumper straps) or through software (configuration of personality registers in 208, 210 and 212). The PCI/PCI-X bus 107 is adapted to connect to a standard PCI connector.

The PCI-X/PCI-X bridge 220 is connected between the PCI-X bus 109 and the PCI-X bus 0 data and control 208, The PCI-X/PCI-X bridge 220 allows existing enumeration code (unmodified) to recognize and handle PCI or PCI-X compliant devices residing on the PCI/PCI-X bus 107. The PCI-X/PCI-X bridge 220, for example, may be used in determining whether an PCI device or a PCI-X device is connected to the PCI-PCI-X bus 107 by bus enumeration during POST.

The PCI/PCI-X logic 218 may function as a host/PCI-X bridge or the PCI-X/PCI-X bridge 220 may be used for PCI-X transactions on the PCI/PCI-X bus 107. In the first case (host/PCI bridge), the PCI-X logic 218 becomes a second host/PCI bridge and the PCI/PCI-X bus 107 becomes a second PCI-X/host bus in the computer system. The PCI-X bus 109 is the primary PCI-X bus and is assigned a logical PCI-X bus number of zero. The PCI/PCI-X bus 107 may be assigned a logical PCI-X bus number of one.

In another embodiment when the PCI/PCI-X bus 107 is serving as an additional PCI bus, the PCI-X/PCI-X bridge 220 in combination with PCI-X logic 218 may be used as a full function PCI/PCI-X bridge between the PCI-X bus 109 and the PCI/PCI-X bus 107. In this embodiment of the present invention, transactions between the host bus 103 and the PCI/PCI-X bus 107 would have to go through both the host/PCI bridge 206 and the now fully functional PCI-X/PCI-X bridge 220.

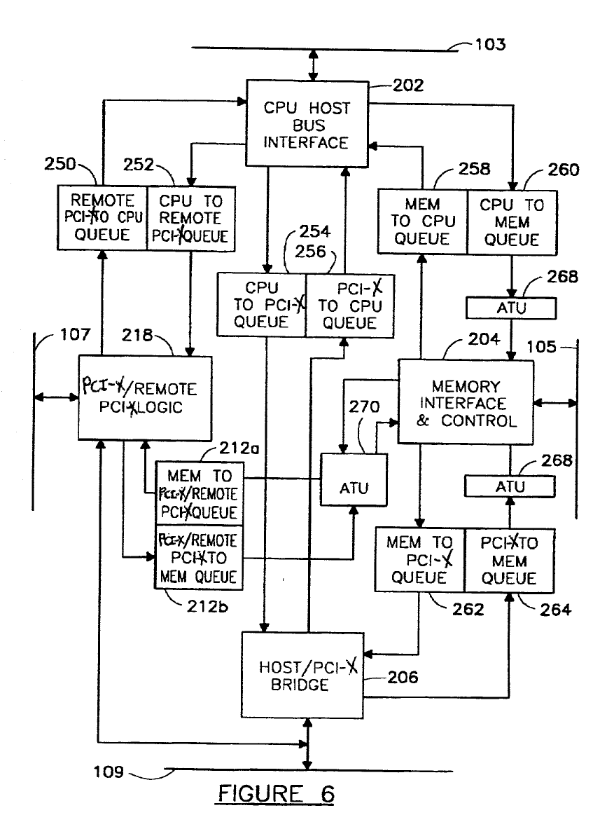

Referring now to FIG. 6, a data flow block diagram of the core logic 104 of FIG. 5, according to the present invention, is illustrated. The core logic 104 communicates through the various queues, read registers, and other control signals (not illustrated). Separating the major function blocks (202, 204, 206 and 218) as illustrated and coupling these function blocks together with read and write queues allows for a significant amount of concurrency in the computer system.

There are ten address and data queues illustrated in FIG. 2A. The queues receiving information (address and data) from the CPU are: CPU to memory queue 260, CPU to PCI-X queue 254, and CPU to PCI-X queue 252. Data directed to the system memory (RAM 106) has the respective base addresses translated to the system memory address space by address translation units (“ATU”) 268.

The queues receiving information directed to the CPU are: memory to CPU queue 258, PCI-X to CPU queue 256, and PCI-X to CPU queue 250. Memory to PCI-X queue 262 receives information from the memory interface and control 204 that is directed to the host/PCI-X bridge 206. PCI-X to memory queue 264 receives information from the host/PCI-X bridge 206 that is directed to the memory interface and control 204. Memory to PCI-X/remote PCI-X queue 212a receives information from the memory interface and control 204 that is directed to the PCI-X/remote PCI-X logic 218. PCI-X/remote PCI-X to memory queue 212b receives information from the PCI-X/remote PCI-X logic 218 that is directed to the memory interface and control 204. Data directed to the system memory (RAM 106) has the respective base addresses translated to the system memory address space by 270.

The CPU to memory queue 260 handles CPU 102 posted writes to the RAM 106. The CPU to PCI-X queue 254 handles CPU 102 writes to the primary PCI-X bus 109. The CPU to PCI-X queue 252 handles CPU 102 writes to either a PCI device or a PCI-X device on the universal PCI/PCI-X bus 207.

The system memory (RAM 106) reads by the CPU 102 are queued in the memory to CPU queue 258. Reads from the PCI-X devices on the primary PCI-X bus 109 are queued in the PCI-X to CPU queue 256. Reads from the PCI device or PCI-X device(s) on the universal PCI/PCI-X bus 207 are queued in the PCI-X to CPU queue 250. With the queues 212a, 212b, 250, 252, the PCI-X logic 218 has the same capabilities as the host to PCI-X bridge 206 when configured as an additional host to PCI-X bridge.

Referring to FIGS. 7 and 8, schematic block diagrams of a computer system motherboard and an expansion box motherboard, respectively, are illustrated in plan views. The computer system motherboard 700 comprises printed circuit board 702 and the expansion box motherboard 800 comprises printed circuit board 802 on which components and connectors are mounted thereto. The printed circuit hoards 702, 802 comprise conductive printed wiring which is used to interconnect the components and connectors thereon. The conductive printed wiring (illustrated as buses 103, 105, 107, 109 and 406) may be arranged into signal buses having controlled impedance characteristics. On the printed circuit hoard 702 are the core logic 104, CPU(s) 102, RAM 106, PCI-X/ISA/EISA bridge 116, ISA/EISA connectors 706, PCI-X connectors 708 (primary PCI-X bus 109), and additional PCI-X connectors 710a and 710h. The PCI-X connectors 710 are the same standard PCI-X connectors as PCI-X connectors 708. On the printed circuit board 802 are the expansion cable interface 402, remote-PCI-X bridge 404, PCI-X/SCSI bus adapter 114, PCI-X/DE controller 118, and PCI-X connectors 808 (remote-PCI-X bus 406). PCI-X device cards may be plugged into the PCI-X connectors 808, such as the NIC 122 and the PCI-X/PCI-X bridge 124 (see FIG. 4).

The core logic 104 has multiple uses, operable as either a PCI interface or an additional PCI-X interface, and may be configured for either a local PCI-X interface or a remote PCI-X interface connected to the PCI-X connectors 710a-710b. Hardware jumper 714 may be utilized to select the core logic 104 interface local/remote PCI-X personality, or configuration registers within the core logic 104 may be set by software during system configuration or POST after enumerating the various computer system buses to determine what peripheral cards have been connected to the PCI/PCI-X bus 107. The present invention allows automatic configuration of the core logic as a PCI interface if a PCI compliant device (not illustrated) is detected on the bus 107 or as an additional PCI-X interface if a PCI-X card is detected in the PCI-X card connectors 710a-710b. The PCI-X connectors 708 are connected to the computer system primary PCI-X bus 109 (logical PCI-X bus number zero). The PCI-X connectors 708 and 710 are standard PCI-X connectors as more fully described in the PCI-X Specification.

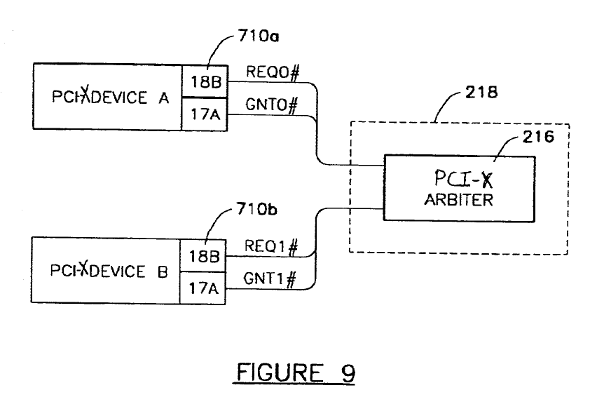

Referring now to FIG. 9, a schematic block wiring diagram of a portion of the embodiment of the present invention according to FIGS. 7 and 8 is illustrated. Each PCI-X device card inserted into a PCI-X connector requires request (REQ#) and grant (GNT#) signals. A PCI-X device is selected and is allowed to become the PCI-X bus initiator when it asserts its respective REQ# signal onto the PCI-X bus and the PCI-X arbiter acknowledges the PCI-X device bus initiator request by asserting the respective GNT# signal back to PCI-X device requesting the PCI-X bus. In the multiple use core logic 104 of the present invention, a plurality of individual request and grant signal lines are available for either a PCI bus device or additional PCI-X bus devices. This is partially illustrated by PCI-X connector 710a connected to REQ0# and GNTO# signal lines and PCI-X connector 710b connected to REQ1# and GNT1# signal lines, all from the PCI-X arbiter 216 of the PCI-X logic 218. All other PCI and or PCI-X connectors and embedded PCI-X devices each have individual REQ and GNT signal lines connected thereto.

Thus, the multiple use core logic chip set of the present invention may be configured for a computer system having either a PCI compliant bus or an additional PCI-X bus having remote-PCI-X bus capabilities, depending only upon the configuration of the computer system printed circuit board 702. In this way one multiple use core logic chip set may be utilized for many differently configured computer systems from simple portable and consumer personal computers to high end workstations and network servers which may require a remote expansion box because of the additional number of peripheral devices required in the computer system.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A computer system having a core logic chip set configurable for either a local Registered Peripheral Component Interconnect (“PCI-X”) bus or a remote PCI-X bus, the system comprising:
a central processing unit connected to a host bus;
a random access memory connected to a random access memory bus;
a core logic chip set connected to the host bus and the random access memory bus;
the core logic chip set configured as a first interface bridge between the host bus and the random access memory bus, a second interface bridge between the host bus and the local PCI-X bus, and a third interface bridge between the random access memory bus and the local PCI-X bus;
the core logic chip set configured as a fourth interface bridge between the host bus and a remote PCI-X bus; and
the core logic chip set configured as a fifth interface bridge between the random access memory bus and the remote PCI-X bus.

2. The computer system of claim 1, the computer system further comprising at least one additional central processing unit connected to the host bus.

3. The computer system of claim 1, wherein the core logic chip set is at least one integrated circuit.

4. The computer system of claim 1, wherein the remote PCI-X bus is connected to at least one external PCI-X device via an optical cable.

5. The computer system of claim 3, wherein the at least one integrated circuit core logic chip set is at least one programmable logic array integrated circuit.

6. The computer system of claim 1, further comprising at least one PCI-X device, the at least one peripheral component interconnect device connected to the remote PCI-X bus.

7. The computer system of claim 1, wherein the fourth and fifth interface bridges include a cable interface comprising drivers and receivers for interfacing with a plurality of insulated wires in an expansion cable.

8. The computer system of claim 7, wherein the drivers are differential drivers and the receivers are differential receivers.

9. The computer system of claim 8, wherein the plurality of insulated wires in the expansion cable arc arranged into a plurality of twisted pairs.

10. The computer system of claim 1, wherein the host bus, random access memory bus, and local PCI-X bus are on a first printed circuit board.

11. The computer system of claim 10, wherein the remote PCI-X bus is on a second printed circuit board.

12. The computer system of claim 11, wherein a second cable interface is on the second printed circuit board and connected to the remote PCI-X bus.

13. The computer system of claim 1, wherein the fourth and fifth interface bridges of the core logic chip set are configured for the remote PCI-X bus by an electrical signal sent from a hardwired jumper circuit located on the first printed circuit board.

14. The computer system of claim 1, wherein the fourth and fifth interface bridges of the core logic chip set are configured for the remote PCI-X bus by software control of the core logic chip set.

15. The computer system of claim 14, wherein the fourth and fifth interface bridges of the core logic chip set are configured for the remote PCI-X bus when a PCI-X device is detected on the remote PCI-X bus.

16. The computer system of claim 15, wherein configuration of the core logic chip set is done during power on self test of the computer system.

17. The computer system of claim 15, wherein configuration of the core logic chip set is done during configuration of the computer system.

18. A computer system having a core logic chip set configurable for either a local Registered Peripheral Component Interconnect (“PCI-X”) bus or a remote PCI-X bus, the system comprising:
a central processing unit connected to a host bus;
a random access memory connected to a random access memory bus;
a core logic chip set connected to the host bus and the random access memory bus;
the core logic chip set configured as a first interface bridge between the host bus and the random access memory bus, a second interface bridge between the host bus and the local PCI-X bus, and a third interface bridge between the random access memory bus and the local PCI-X bus;
the core logic chip set configured as a fourth interface bridge between the host bus and the remote PCI-X bus; and
the core logic chip set configured as a fifth interface bridge between the random access memory bus and the remote PCI-X bus;
wherein the fourth and fifth interface bridges include a cable interface comprising drivers and receivers for interfacing with a plurality of insulated wires in an expansion cable.

19. The computer system of claim 18, wherein the cable interface comprises drivers and receivers for interfacing with a plurality of insulated wires in an expansion cable.

20. The computer system of claim 18, wherein the expansion cable is an optical cable.
